(19) United States
(12) Patent Application Publication
(10) Pub. No.: US 2013/0321362 A1
(43) Pub. Date: Dec. 5, 2013

(54) Display Panel and Drive Method of Panel Display Device

(71) Applicants: Hua Zheng, Shenzhen (CN); Cheng-hung Chen, Shenzhen (CN)

(72) Inventors: Hua Zheng, Shenzhen (CN); Cheng-hung Chen, Shenzhen (CN)

(73) Assignee: SHENZHEN CHINA STAR OPTOELECTRONICS TECHNOLOGY CO. LTD., Shenzhen, Guangdong (CN)

(21) Appl. No.: 13/522,700

(22) PCT Filed: Jun. 13, 2012
(86) PCT No.: PCT/CN2012/076834

§ 371 Date: Jul. 17, 2012

(30) Foreign Application Priority Data
Jun. 5, 2012 (CN) 201210183084.8

(51) Int. Cl. G06F 3/038

(52) U.S. Cl. 345/204

(57) ABSTRACT

The present invention discloses a display panel, including data IC and at least two scan ICs. Data IC includes input and output terminals of first scan signal. Scan IC includes input and output terminals of second scan signal. Input terminal of each scan IC is connected to output terminal of first scan signal on data IC through respective wire. Wires have equal resistance or have resistance difference smaller than a default value. The present invention also provides a panel display device and drive method thereof. As such, the present invention can improve luminance uniformity of display panel.

### BACKGROUND OF THE INVENTION

1. Field of the Invention

The present invention relates to the field of panel displaying techniques, and in particular to a display panel and method of panel display device.

2. The Related Arts

Panel display device has the advantages of flat, reduced thickness, light weight, and low power consumption so that the panel display device is replacing conventional CRT display to become the mainstream of display device. As the technologies develop, users have higher demands of panel display devices to obtain better display quality.

The parameters affecting panel display device are mainly contrast, luminance, viewable angle, response time, and so on. In particular, the luminance of the display panel is an important indicator in evaluating the quality of the panel display device. Besides backlight source, the luminance of display panel also depends on routing (layout) of drive IC of display panel.

Refer to FIG. 1 and FIG. 2. Panel display device comprises a display panel 11, printed circuit board (PCB) 12, source IC 13, first gate IC 14 and second gate IC 15. PCB 12 and source IC 13 are disposed on a side of data line (not shown) of vertical display panel. Source IC 13 is electrically connected to PCB 12. First gate IC 14 and second gate IC 15 are disposed on a side of gate line (not shown) of vertical display panel. First gate IC 14 is closer to the outmost source IC 13, and second gate IC 14 is farther from the outmost source IC 13. Third gate IC 16 and fourth gate IC 17 are distributed in a manner symmetrical to first gate IC 14 and second gate IC 15. Third gate IC 16 and fourth gate IC 17 can also be distributed on the same side of display panel 11.

Refer to FIG. 1 and FIG. 2. For routing of the above drive ICs, taking first gate IC 14 and second gate IC 15 as example, a known routing is: PCB 12 supplying gate signal (VGH) to first gate IC 14 and second gate IC 15, VGH passing metal wire 1 to first gate IC 14, first gate IC 14 outputting VGH, and VGH passing metal wire 2 to second gate IC 15.

In known drive IC routing, gate signal VGH must pass additional metal wire 2 to arrive at second gate IC 15 than to arrive at first gate IC 14. Metal wire 2 ahs additional resistance and parasitic capacitance. Therefore, amplitude and waveform of VGH arriving at second gate IC 15 are different from amplitude and waveform of VGH arriving at first gate IC 14. As shown in FIG. 3, diagram 21 is an amplitude and waveform of VGH arriving at first gate IC 14 and diagram 22 is an amplitude and waveform of VGH arriving at second gate IC 15. Because input signals to first gate IC 14 and second gate IC 15 are different, output amplitudes and waveforms are different correspondingly. As shown in FIG. 4, diagram 23 is an amplitude and waveform of VGH outputted from first gate IC 14 and diagram 24 is an amplitude and waveform of VGH outputted from second gate IC 15. Because input and output amplitudes and waveforms of first gate IC 14 and second gate IC 15 are all different, active area controlled by second gate IC 15 has a lower luminance of active area controlled by first gate IC 14 on display panel 11. As most display panels are designed with lateral gate lines, luminance of display panel 11 shows a vertical distribution. The non-uniformity of luminance distribution will affect the display result of display panel.

### SUMMARY OF THE INVENTION

The technical issue to be addressed by the present invention is to provide a display panel and drive method of panel display device, to make luminance distribution of display panel more uniform and to enhance the quality of displaying.

The present invention provides a display panel, which comprises: a plurality of scan lines, a plurality of data lines, a data IC and at least two scan ICs; scan lines being disposed horizontally, and data lines being disposed vertically; data IC being disposed on a side in a direction perpendicular to data lines, and scan ICs being disposed on a side in a direction perpendicular to scan lines; data IC comprising input terminal of first scan signal, input terminal of data signal, output terminal of first scan signal and output terminal of data signal; scan ICs comprising: input terminal of second scan signal and output terminal of second scan signal; input terminal of second scan signal on each of scan ICs being electrically connected to output terminal of first scan signal on data IC through respective wire, respective wires having equal resistance or having a resistance difference smaller than a default value; scan lines being electrically connected to output terminal of second scan signal on scan ICs, and data lines being electrically connected to output terminal of data signal on data IC; and all wires having equal resistance or having resistance difference smaller than a default value.

According to a preferred embodiment of the present invention, all wires comprise common part and branch part; number of branch parts of wire is equal to number of scan ICs; common part of wire corresponds to at least branch parts of two wires; one end of common part of wire is electrically connected to output terminal of first scan signal on data IC, the other end is electrically connected to one end of branch part of at least two wires, the other end of branch part of each wire is electrically connected to input terminal of second scan signal on corresponding scan IC.

According to a preferred embodiment of the present invention, number of common part of a wire is 1, and all branch parts of all wires have equal resistivity and length.

According to a preferred embodiment of the present invention, the common part of wire passes a scan IC.

According to a preferred embodiment of the present invention, at least a scan IC comprises a third input terminal and a third output terminal, at least a conductive path enters scan IC through the third input terminal, and exits from scan IC through third output terminal.

The present invention provides a panel display device, which comprises: a display panel; the display panel comprises: a plurality of scan lines, a plurality of data lines, a data IC and at least two scan ICs; scan lines being disposed horizontally, and data lines being disposed vertically; data IC being disposed on a side in a direction perpendicular to data lines, and scan ICs being disposed on a side in a direction perpendicular to scan lines; data IC comprising input terminal of first scan signal, input terminal of data signal, output terminal of first scan signal and output terminal of data signal; scan ICs comprising: input terminal of second scan signal and output terminal of second scan signal; input terminal of second scan signal on each of scan ICs being electrically connected to output terminal of first scan signal on data IC through respective wire, respective wires having equal resistance or having a resistance difference smaller than a default value; scan lines being electrically connected to output terminal of second scan signal on scan ICs, and data lines being electrically connected to output terminal of data signal on data IC.

According to a preferred embodiment of the present invention, all wires have equal resistance or have resistance difference smaller than a default value.

According to a preferred embodiment of the present invention, all wires comprise common part and branch part; number of branch parts of wire is equal to number of scan ICs; common part of wire corresponds to at least branch parts of two wires; one end of common part of wire is electrically connected to output terminal of first scan signal on data IC, the other end is electrically connected to one end of branch part of at least two wires, the other end of branch part of each wire is electrically connected to input terminal of second scan signal on corresponding scan IC.

According to a preferred embodiment of the present invention, number of common part of a wire is 1, and all branch parts of all wires have equal resistivity and length.

According to a preferred embodiment of the present invention, the common part of wire passes a scan IC.

According to a preferred embodiment of the present invention, at least a scan IC comprises a third input terminal and a third output terminal, at least a conductive path enters scan IC through the third input terminal, and exits from scan IC through third output terminal.

The present invention provides a drive method of panel display device, which comprises: supplying scan drive signal through respective wires having equal resistance or having resistance difference smaller than a default value to at least two scan ICs to drive pixel switch conductive; after pixel switch becoming conductive, supplying data drive signal to data IC to make data drive signal passing conductive switch to enter respective pixel operation element.

According to a preferred embodiment of the present invention, the step of supplying scan drive signal through respective wires having equal resistance or having resistance difference smaller than a default value to at least two scan ICs to drive pixel switch conductive is specifically as: a data IC supplying scan drive signal through respective wires having equal resistance or having resistance difference smaller than a default value to at least two scan ICs to drive pixel switch conductive.

According to a preferred embodiment of the present invention, all wires have common part and branch part; number of branch part of wire is equal to number of scan ICs, and common part of wire at least corresponds to branch part of two wires.

According to a preferred embodiment of the present invention, number of common part of a wire is 1, common part passes a scan IC, and all branch parts of all wires have equal resistivity and length.

The efficacy of the present invention is that to be distinguished from the state of the art. The present invention connects input terminal of scan signal on each scan IC to output terminal of scan signal on data IC through respective wire, and makes wires corresponding to at least two scan ICs have equal resistance or have resistance difference smaller than a default value so that amplitudes and waveforms of signal inputs to at least two scan ICs are the same so as to reduce or even eliminate luminance vertical distribution phenomenon of display panel, make luminance distribution uniform and enhance displaying equality of display panel.

### BRIEF DESCRIPTION OF THE DRAWINGS

To make the technical solution of the embodiments according to the present invention, a brief description of the drawings that are necessary for the illustration of the embodiments will be given as follows. Apparently, the drawings described below show only example embodiments of the present invention and for those having ordinary skills in the art, other drawings may be easily obtained from these drawings without paying any creative effort. In the drawings:

FIG. 1 is a schematic view showing the routing of a known drive IC of display panel;

FIG. 2 is an enlarged view of the dash-line area in FIG. 1;

FIG. 3 is a plot showing input amplitudes and waveforms of first gate IC and second gate IC in the routing of a known technique shown in FIG. 2;

FIG. 4 is a plot showing output amplitudes and waveforms of first gate IC and second gate IC in the routing of a known technique shown in FIG. 2;:

FIG. 5 is a schematic view showing the structure of an embodiment of a display panel according to the present invention; and

FIG. 6 is a flowchart of an embodiment of the drive method of panel display device according to the present invention.

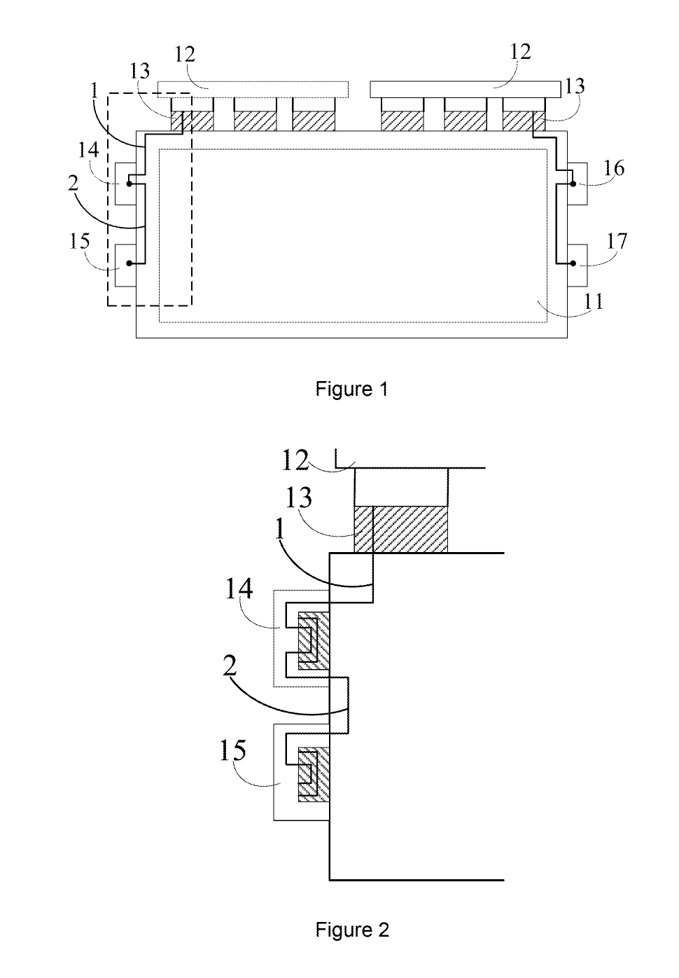

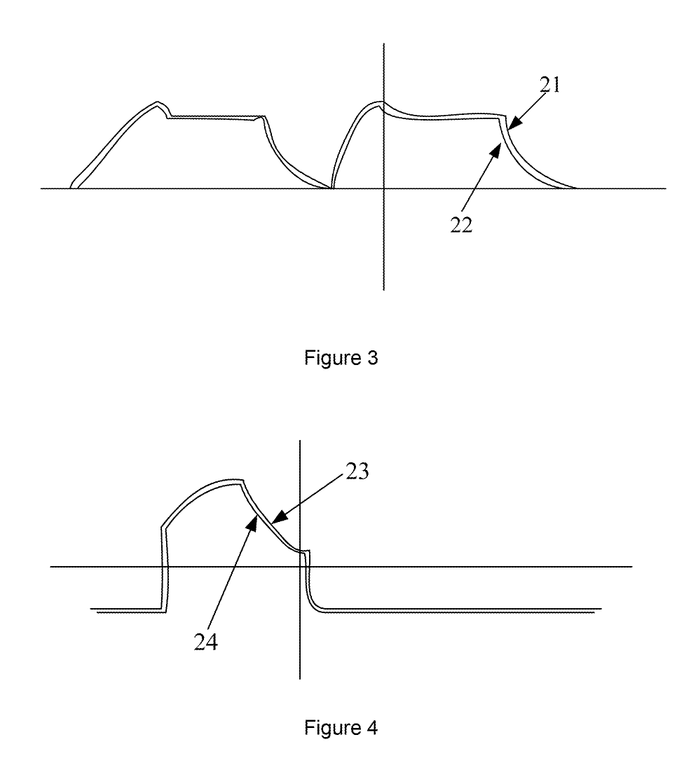

### DETAILED DESCRIPTION OF THE PREFERRED EMBODIMENTS

The display panel of the present invention can reduce or even eliminate luminance vertical distribution phenomenon of display panel, make luminance distribution uniform and enhance displaying equality of display panel.

The following description refers to drawings and embodiments of the present invention.

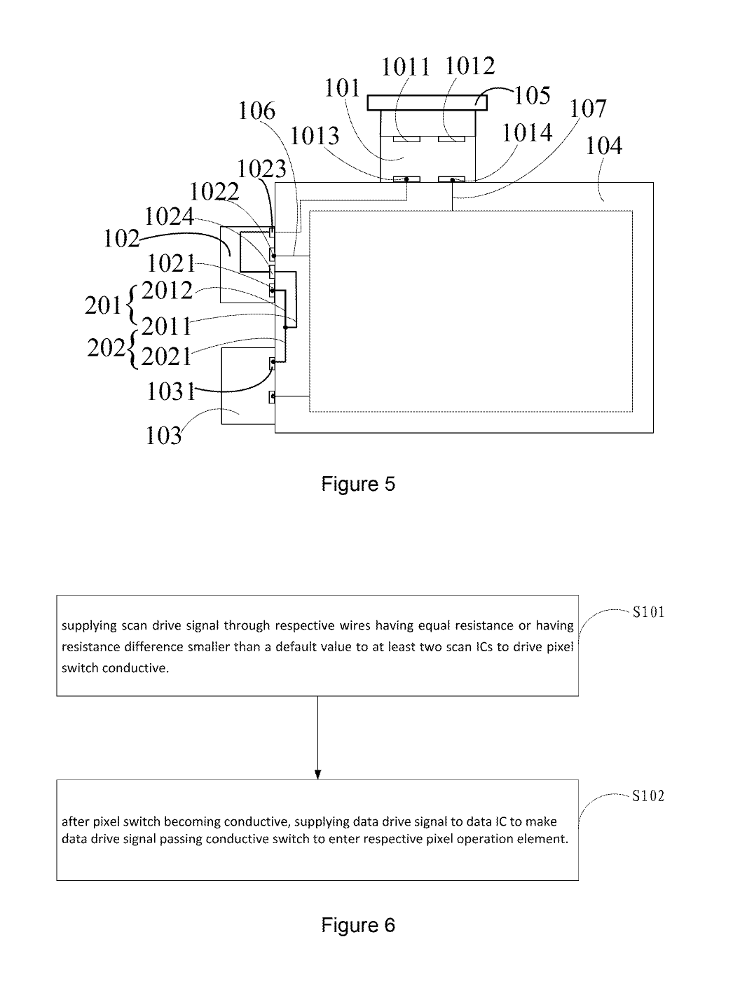

Refer to FIG. 5. An embodiment of the display panel of the present invention comprises a plurality of scan lines 106, a plurality of data lines 107, a data IC 101, a first scan IC 102, a second scan IC 103 and a printed circuit board (PCB) 105. Scan lines 106 are disposed horizontally, and data lines 107 are disposed vertically. Data IC 101, first scan IC 102 and second scan IC 103 are disposed at side area 104 of display panel. In the instant embodiment, data lines 107 are disposed vertically on display panel and scan lines 106 are disposed laterally (horizontally) on display panel. Data IC 101 is disposed on a side in a direction perpendicular to data lines 107, and first scan IC 102 and second scan IC 103 are disposed on a side in a direction perpendicular to scan lines 106.

Data IC 101 comprises input terminal 1011 of first scan signal, input terminal 1012 of data signal, output terminal 1013 of first scan signal and output terminal 1014 of data signal. Scan ICs comprise, taking first scan IC 102 as example, input terminal 1021 of second scan signal and output terminal 1022 of second scan signal. Because data IC 101 is connected to PCB 105, which supplies data drive signal and scan drive signal to data IC 101, first scan IC 102 and second scan IC 103, input terminal and output terminal of scan drive signal must be disposed on data IC 101, i.e., input terminal 1011 of first scan signal and output terminal 1013 of first scan signal, so that scan drive signal is propagated through data IC 101 to first scan IC 102 and second IC 103.

Specifically, input terminal 1021 of second scan signal on first scan IC 102 is electrically connected to output terminal 1013 of first scan signal on data IC 101 through wire 201, and input terminal 1031 of second scan signal on second scan IC 103 is electrically connected to scan line 106 to supply scan drive signal to scan line 106. Input terminal 1031 of second scan signal on second scan IC 103 is electrically connected to output terminal 1013 of first scan signal on data IC 101 through wire 202. Input terminal 1011 of first scan signal of data IC 101 and input terminal 1012 of data signal are electrically connected to PCB 105. Output terminal 1014 of data signal is connected to data line 107 to supply data drive signal to data line 107. When PCB 105 supplies scan drive signal to first scan IC 102 and second scan IC 103, scan drive signal is inputted through input terminal 1011 of first scan signal of data IC 101, passes wire 201 and wire 202 respectively to first scan IC 102 and second scan IC 103. First scan IC 102 and second scan IC 103 supplies scan drive signal to scan line 106 through output terminal 1022 of second scan signal. When PCB 105 supplies data drive signal to data IC 101, data drive signal is inputted directly through input terminal 1012 of data signal to data IC 101, and then outputted from output terminal 1014 of data signal to data line 107.

In the instant embodiment, wire 201 and wire 202 have equal resistance. Wire 201 and wire 202 both comprise common part and branch part. As shown in FIG. 5, wire 201 comprises main wire 2011 and first branch wire 2012. Wire 202 comprises main wire 2011 and second branch wire 2021. Main wire 2011 is common part of wire 201 and wire 202. First branch wire 2012 is branch part of wire 201, and second branch wire 2021 is branch part of wire 202. Main wire 2011 passes first scan IC 102. At this point, first scan IC 102 further comprises third input terminal 1023 and third output terminal 1024. Main wire 2011 enters first scan IC 102 through third input terminal 1023 and exits from first scan IC 102 through third output terminal 1024. One end of main wire 2011 is electrically connected to output terminal 1013 of first scan signal of data IC 101, and the other end is electrically connected to one end of first branch wire 2012 and second branch wire 2021. The respective other end of first branch wire 2012 and second branch wire 2021 is connected to input terminal 1021 of second scan signal of first scan IC 102 and input terminal 1031 of second scan signal of second scan IC 103, respectively. In addition, first branch wire 2012 and second branch wire 2021 have equal resistivity and length so that wire 201 and wire 202 have equal resistance. It should be understood that in actual application, when two wires cannot achieve equal resistance for a certain reason, it should be allowed that wire 201 and wire 202 have a resistance difference smaller than a default value. The default value depends on actual application and should be as small as possible under the possible technologies.

It should also be noted that number of scan ICs of the present invention is at least two. Taking the number two scan ICs as example, the two scan ICs of the present invention are first scan IC 102 and second scan IC 103 respectively, and corresponding number of branch parts of wires is also two, i.e., first branch wire 2012 and second branch wire 2021. In other words, number of branch parts of wires is equal to number of scan ICs. Common part of a wire corresponds to branch parts of two wires. As shown in FIG. 5, a main wire 2011 is connected to both first branch wire 2012 and second branch wire 2021.

In the embodiment of the display panel of the present invention, scan drive signal is first propagated through main wire 2011 and passing first branch wire 2012 and second branch wire 2021 respectively to first scan IC 102 and second scan IC 103 respectively. By designing resistivity and length of first branch wire 2012 and second branch wire 2021 to be equal, wire 201 and wire 202 have equal resistance or have resistance difference smaller than a default value so that amplitude and waveform of signal input to first scan IC 102 and second scan IC 103 would be as close to equal as possible. A such, the present invention can reduce or even eliminate luminance vertical distribution phenomenon of display panel, make luminance distribution uniform and enhance displaying equality of display panel.

It is obvious that in many other embodiments, the number of scan ICs can be three or more, and corresponding number of branch parts should also be three or more. In this situation, common part of a wire corresponds to at least branch parts of three wires. For example, when three scan ICs are used. A main wire is connected to three branch wires simultaneously, the three wires formed by the main wire and three branch wires respectively have equal resistance or have resistance difference smaller than a default value, and three branch wires have equal resistivity and length. Even furthermore, two or more main wires can be disposed so that two or more main wires are connected to more branch wires than the number of main wires. Each wire formed by main wire and branch wire must have equal resistance or have resistance difference smaller than a default value. The description of number of scan ICs will not be repeated here. The number of data ICs in the present invention can also be plural and not specific limitation is described here. When number of data ICs is plural, scan drive signal is propagated by the data IC closest to scan ICs. In addition, common part of wire can also bypass scan IC. Even further, scan drive signal can also bypass data IC and be inputted from PCB to scan IC.

An embodiment of a panel display device of the present invention comprises the aforementioned display panel, and the panel display device of the present invention can be liquid crystal display device, plasma display device, OLED display device or other types of panel display device.

Refer t0 FIG. 6. An embodiment of a drive method of panel display device of the present invention comprises the steps of:

Step S101: supplying scan drive signal through respective wires having equal resistance or having resistance difference smaller than a default value to at least two scan ICs to drive pixel switch conductive.

Specifically, PCB is connected to display panel through drive IC, and PCB supplies scan signal to at least two scan ICs through corresponding wires having equal resistance or having resistance difference smaller than a default value and through a data IC.

All the above wires comprise common part and branch part, and number of branch part of wire is equal to number of scan ICs. Number of common part of a wire is 1 and common part passes a scan IC. Common part of a wire at least corresponds to branch part of two wires.

Specifically, number of scan ICs is at least two. Number of branch part of wires is at least two. Number of wires formed by common part respectively with at least two branch parts is two so that scan signal passes at least two paths to at least two scan ICs. Taking FIG. 5 and the two scan ICs as example, scan drive signal is inputted to first scan IC 102 through wire 201 and scan drive signal is inputted to second scan IC 103 through wire 202. As such, pixel switch is turned conductive. In the instant embodiment, wire 201 is formed by main wire 2011 and first branch wire 2012, and wire 202 is formed by main wire 20111 and second branch wire 2021. Main wire 2011 is common part of wire 201 and wire 202. First branch wire 2012 is the branch part of wire 201 and second branch wire 2021 is the branch part of wire 202. First branch wire 2012 and second branch wire 2021 have equal resistivity and length so that wire 201 and wire 202 have equal resistance or have resistance difference smaller than a default value.

Step S102: after pixel switch becoming conductive, supplying data drive signal to data IC to make data drive signal passing conductive switch to enter respective pixel operation element.

In step S101, after scan drive signal inputted to scan IC to make pixel switch conductive, data IC supplies data drive signal passing conductive pixel switch to enter corresponding pixel operation elements, such as, entering pixel electrodes of liquid crystal display device to drive panel display device to display.

The drive method of panel display device of the present invention supplies drive signal to at least two scan ICs through respective wires having equal resistance or having resistance difference smaller than a default value so that amplitudes and waveforms of signal inputs to at least two scan ICs are the same so as to reduce or even eliminate luminance vertical distribution phenomenon of display panel, make luminance distribution uniform and enhance displaying equality of display panel.

Embodiments of the present invention have been described, but not intending to impose any unduly constraint to the appended claims. Any modification of equivalent structure or equivalent process made according to the disclosure and drawings of the present invention, or any application thereof, directly or indirectly, to other related fields of technique, is considered encompassed in the scope of protection defined by the clams of the present invention.

What is claimed is:

1. A display panel, which comprises:
a plurality of scan lines, a plurality of data lines, a data IC and at least two scan ICs;
the scan lines being disposed horizontally, and the data lines being disposed vertically;
the data IC being disposed on a side in a direction perpendicular to data lines, and the scan ICs being disposed on a side in a direction perpendicular to scan lines;
the data IC comprising input terminal of first scan signal, input terminal of data signal, output terminal of first scan signal and output terminal of data signal;
the scan ICs comprising: input terminal of second scan signal and output terminal of second scan signal;
input terminal of second scan signal on each of scan ICs being electrically connected to output terminal of first scan signal on data IC through respective wire, respective wires having equal resistance or having a resistance difference smaller than a default value;
scan lines being electrically connected to output terminal of second scan signal on scan ICs, and data lines being electrically connected to output terminal of data signal on data IC; and
all wires having equal resistance or having resistance difference smaller than a default value.

2. The display panel as claimed in claim 1, characterized in that:
all wires comprise common part and branch part;
number of branch parts of wire is equal to number of scan ICs; a common part of wire corresponds to at least branch parts of two wires;
one end of common part of wire is electrically connected to output terminal of first scan signal on data IC, the other end is electrically connected to one end of branch part of at least two wires, the other end of branch part of each wire is electrically connected to input terminal of second scan signal on corresponding scan IC.

3. The display panel as claimed in claim 2, characterized in that:
number of common part of a wire is 1, and all branch parts of all wires have equal resistivity and length.

4. The display panel as claimed in claim 3, characterized in that:
the common part of wire passes a scan IC.

5. The display panel as claimed in claim 4, characterized in that:
at least a scan IC comprises a third input terminal and a third output terminal, at least a conductive path enters scan IC through the third input terminal, and exits from scan IC through third output terminal.

6. A panel display device, which comprises a display panel; the display panel further comprises:
a plurality of scan lines, a plurality of data lines, a data IC and at least two scan ICs;
the scan lines being disposed horizontally, and the data lines being disposed vertically;
the data IC being disposed on a side in a direction perpendicular to data lines, and the scan ICs being disposed on a side in a direction perpendicular to scan lines;
the data IC comprising input terminal of first scan signal, input terminal of data signal, output terminal of first scan signal and output terminal of data signal;
the scan ICs comprising: input terminal of second scan signal and output terminal of second scan signal;
input terminal of second scan signal on each of scan ICs being electrically connected to output terminal of first scan signal on data IC through respective wire, respective wires having equal resistance or having a resistance difference smaller than a default value; and
scan lines being electrically connected to output terminal of second scan signal on scan ICs, and data lines being electrically connected to output terminal of data signal on data IC.

7. The panel display device as claimed in claim 6, characterized in that:
all wires have equal resistance or have resistance difference smaller than a default value.

8. The panel display device as claimed in claim 7, characterized in that:
all wires comprise common part and branch part;
number of branch parts of wire is equal to number of scan ICs; a common part of wire corresponds to at least branch parts of two wires;
one end of common part of wire is electrically connected to output terminal of first scan signal on data IC, the other end is electrically connected to one end of branch part of at least two wires, the other end of branch part of each wire is electrically connected to input terminal of second scan signal on corresponding scan IC.

9. The panel display device as claimed in claim 8, characterized in that:
number of common part of a wire is 1, and all branch parts of all wires have equal resistivity and length.

10. The panel display device as claimed in claim 9, characterized in that:
the common part of wire passes a scan IC.

11. The panel display device as claimed in claim 10, characterized in that:
at least a scan IC comprises a third input terminal and a third output terminal, at least a conductive path enters scan IC through the third input terminal, and exits from scan IC through third output terminal.

12. A drive method of panel display device, which comprises:
supplying scan drive signal through respective wires having equal resistance or having resistance difference smaller than a default value to at least two scan ICs to drive pixel switch conductive;
after pixel switch becoming conductive, supplying data drive signal to data IC to make data drive signal passing conductive switch to enter respective pixel operation element.

13. The drive method as claimed in claim 12, characterized in that:
the step of supplying scan drive signal through respective wires having equal resistance or having resistance difference smaller than a default value to at least two scan ICs to drive pixel switch conductive is specifically as: a data IC supplying scan drive signal through respective wires having equal resistance or having resistance difference smaller than a default value to at least two scan ICs to drive pixel switch conductive.

14. The drive method as claimed in claim 12, characterized in that:
all wires have common part and branch part;
number of branch part of wire is equal to number of scan ICs, and common part of wire at least corresponds to branch part of two wires.

15. The drive method as claimed in claim 14, characterized in that;
number of common part of a wire is 1, common part passes a scan IC, and all branch parts of all wires have equal resistivity and length.
